(19) United States
(12) Patent Application Publication
(10) Pub. No.: US 2025/0314018 A1
(43) Pub. Date: Oct. 9, 2025

(54) SYNTHETIC TURF WITH COMPOSITE BACKING

(71) Applicant: Watershed Geosynthetics, LLC, Alpharetta, GA (US)

(72) Inventors: Delaney LEWIS, Downsville, LA (US); Jose URRUTIA, Atlanta, GA (US); Bradford COOLEY, Chattanooga, TN (US); Edward ZIMMEL, Magnolia, TX (US)

(73) Assignee: Watershed Geosynthetics, LLC, Alpharetta, GA (US)

(21) Appl. No.: 19/169,808

(22) Filed: Apr. 3, 2025

Related U.S. Application Data
(60) Provisional application No. 63/573,781, filed on Apr. 3, 2024.

(51) Int. Cl. E01C 13/08; D06N 7/00

(52) U.S. Cl. CPC E01C 13/08; D06N 7/0068; D10B 2505/202

(57) ABSTRACT

A synthetic turf cover system for covering various types of sloping ground includes synthetic grass blades tufted into and through a composite backing, with the composite backing including a non-woven synthetic textile lower layer and a woven textile upper layer positioned above and adjacent the non-woven synthetic textile lower layer. The non-woven synthetic textile lower layer provides good interface shear strength with the ground or a ground-covering membrane, while the woven textile upper lawyer provides good strength. The synthetic turf cover system provides good cushioning to help protect the geomembrane against damage from vehicles driving on the synthetic turf cover system.

### BACKGROUND

Artificial grass has been extensively used in sport arenas (playing fields) as well as along airport runways and in general landscaping. A primary consideration of artificial turf playing fields is the ability of the field to drain. Examples of prior art in synthetic grass drainage are U.S. Pat. Nos. 5,876,745; 6,858,272; 6,877,932 and 6,946,181. However, these applications are generally only for field playing surfaces where the ground is substantially flat and the concern is only with the ability to improve field playing conditions.

### SUMMARY OF THE INVENTION

Briefly described, the present invention provides a new and useful system for covering various types of ground, such as where water or wind erosion protection are needed. More particularly, the cover system of this invention comprises a synthetic turf cover system which includes a plurality of synthetic grass blades and a composite backing, with the synthetic grass blades extending above the composite backing, with the synthetic grass blades tufted into the composite backing. The composite backing comprises a woven synthetic textile upper layer and a non-woven synthetic textile lower layer. The synthetic grass blades are tufted into and through both the woven textile upper layer and the non-woven synthetic textile lower layer.

Advantageously, the composite backing provides benefits of two dissimilar materials. The upper layer of woven synthetic textile provides good strength, while the lower non-woven synthetic layer provides good interface shear strength with an underlaying surface, such as the ground or a geomembrane, and good cushioning to resist damage to the geomembrane when a vehicle drives over the synthetic turf and geomembrane. In the case of a geomembrane, the lower synthetic non-woven layer provides good resistance against the synthetic turf slipping down slopes relative to the geomembrane. This slip resistance is especially useful on sloping terrain. Meanwhile, the upper woven synthetic textile layer portion of the composite backing provides good strength, such as against tearing when subjected to tensile and/or shear forces.

Optionally, the non-woven synthetic textile lower layer can comprise a needle punched synthetic non-woven. Also optionally, the non-woven synthetic textile lower layer can comprise an air-laid synthetic non-woven. Also optionally, the non-woven synthetic textile lower layer can comprise continuous filaments or thermally bonded continuous filaments.

Preferably, the non-woven synthetic textile lower layer has a mass per unit area of between about 2 oz/yd² and 18 oz/yd² mass per unit area.

Optionally, the non-woven textile lower layer is positioned for direct contact with a ground surface or with a geomembrane covering the ground.

Optionally, the woven synthetic textile upper layer can comprise two woven synthetic textile layers. Preferably, the woven textile upper layer comprises a first woven synthetic textile and a second woven synthetic textile, with the two woven synthetic textiles comprising different synthetic materials.

Preferably, the synthetic grass blades have a density of between about 10 ounces per square yard and 120 ounces per square yard. Preferably, the synthetic grass blades have a thickness of at least about 100 microns. Preferably, the synthetic grass blades comprise fibers with an average length of between about 0.5 and 3 inches.

Most preferably, the synthetic grass blades comprise fibers with an average length of between about 1 and 1½ inches.

The combination of the woven and non-woven synthetic textiles in the composite backing provides for higher permeability, better filtration from underlying sediment and multi-directional strength compared to known cover systems. Importantly, it also provides for excellent resistance to slipping relative to a geomembrane, due to the relatively high interface shear strength between the lower non-woven layer of the composite backing and the geomembrane. It also provides for increased cushioning of the geomembrane, such as can be useful when vehicles are driven over the surface.

In another example form, the present invention relates to a synthetic turf system including both geomembrane and a synthetic turf positioned over and in contact with the geomembrane. Preferably, the geomembrane is positioned atop a ground surface. Also preferably, the synthetic turf is positioned atop the geomembrane and is in direct contact with the geomembrane. The synthetic turf includes a composite backing comprising a non-woven synthetic textile lower layer and a woven textile upper layer positioned above and adjacent the non-woven synthetic textile lower layer. Preferably, the synthetic grass blades extend above the composite backing and through the composite backing, with the synthetic grass blades being tufted into the composite backing.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

### BRIEF DESCRIPTION OF THE DRAWING FIGURES

FIG. 1 is a schematic, sectional view of a synthetic turf according to an example embodiment of the present invention.

FIG. 2 is a schematic, sectional view of a portion of the synthetic turf of FIG. 1, shown positioned on a membrane over sloping ground.

FIG. 3 is a detailed schematic, sectional view of a portion of the synthetic turf of FIG. 1, shown positioned atop a membrane.

FIG. 4 is a detailed schematic, sectional view of a portion of the synthetic turf of FIG. 1, shown positioned atop another form of membrane.

### DETAILED DESCRIPTION

The present invention provides an erosion protection layer for use in embankments, levees, water channels, landfills and other sloped topographic ground conditions.

In the present invention, synthetic grass blades are used in combination with a composite backing having a non-woven synthetic textile lower layer and at least one woven synthetic textile upper layer, to provide a new and useful ground cover system, while also providing a beneficial erosion protection system that does not require maintenance. This combination (with a composite backing) can be especially effective on covering slopes, including slopes capped with a geomembrane of HDPE, LLDPE, PVC, etc.

With the cover system of this invention, owners and operators can realize significant cost savings by constructing a cover system with synthetic grass that does not require the vegetative support and topsoil layer of the typical known final cover systems. This construction allows for relatively thin closures to accommodate vehicles on relatively steep slows while minimizing or avoiding damage to the underlying geomembrane.

The cover system of this invention is preferably designed as a synthetic turf cover system having a composite backing which includes a non-woven synthetic textile lower layer and one or more woven textile upper layers positioned above and adjacent the non-woven synthetic textile lower layer. A plurality of synthetic grass blades extend above the composite backing, and the synthetic grass blades are tufted into the composite backing.

With this invention, an anchoring system typically associated with exposed covers is optional. Moreover, the turf can be ballasted or not, as desired. If ballasted, one can ballast the turf with approximately about 0.25 to about 1.0 inch of granular infill, which produces a weight of about 3 to about 10 pounds per square foot.

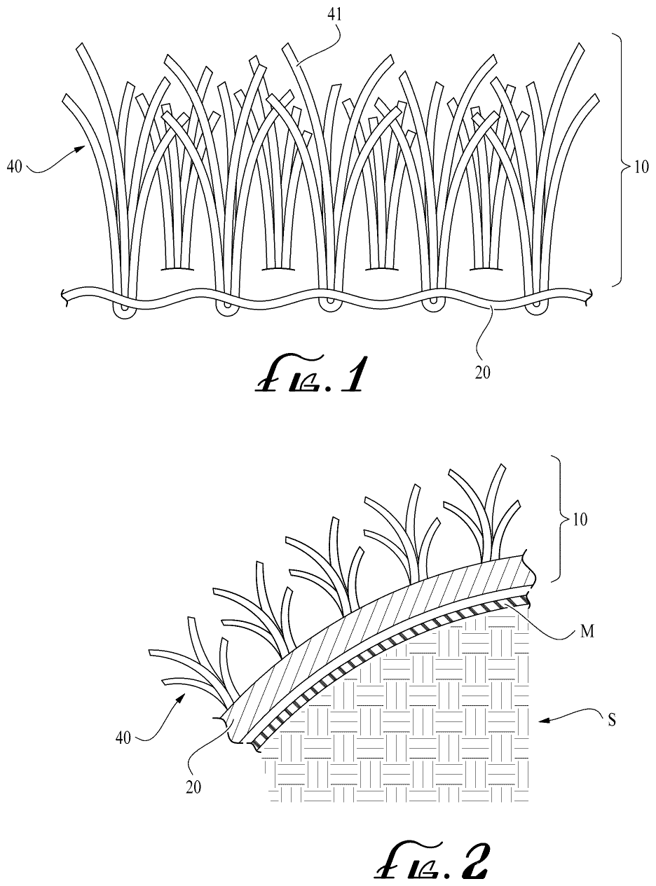

FIG. 1 is a schematic, sectional view of a closure system according the present invention and showing the soil surface covered with the present ground cover erosion control system or closure system 10. The closure system 10 includes a composite backing 20 and a synthetic turf 40 made up of a large plurality of individual synthetic turf blades, such as synthetic turf blade 41. Preferably, the composite backing 20 comprises both a woven synthetic fabric and a non-woven synthetic material, as will be discussed in greater detail below.

As shown in FIG. 2, the synthetic turf 10 of FIG. 1 can be positioned on a membrane M over sloping ground with soil S. Again, preferably, the composite backing 20 comprises both a woven synthetic fabric and a non-woven synthetic material. The non-woven synthetic lower layer of the composite backing 20 provides good interface shear strength against the surface of the membrane or geomembrane M and resists slipping, helping the synthetic turf 10 to stay in place on the sloping ground. This is especially useful at landfills, which typically have steeply sloping sides as the landfills are constructed and filled in with waste.

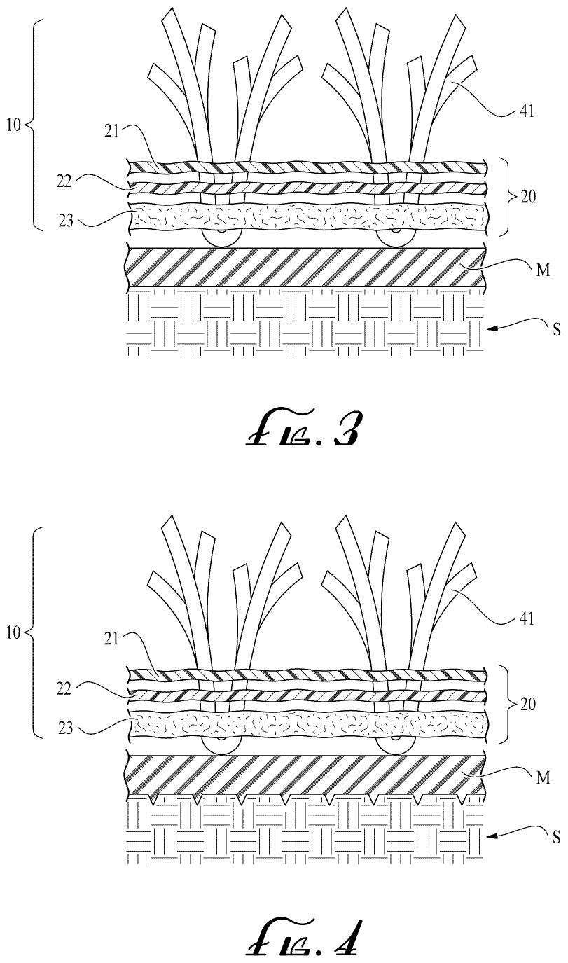

FIG. 3 is a detailed schematic, sectional view of a portion of the synthetic turf 10 of FIG. 1, shown positioned atop a membrane M over soil S. In this example embodiment, the composite backing 20 comprises a first woven synthetic fabric layer 21, a second woven synthetic fabric layer 22, and a non-woven synthetic material layer 23. The synthetic turf blades, such as turf blade 41, are tufted through all three layers of the composite backing 20 such that the three layers of the composite backing form a compressed mat. For clarity of illustration of the different layers, FIGS. 3 and 4 show the layers as separated from one another, to aid the reader in distinguishing the layers in the drawings. In actual construction, the layers are in substantial contact with one another such that significant gaps are not present between the layers.

Optionally, the membrane or geomembrane M can be smooth on both sides as shown in FIG. 3. Alternatively, the membrane or geomembrane M can be smooth on the upper side and spiked or textured on the lower side as shown in FIG. 4, to improve its grip on the soil S on severely sloping ground. Alternatively, the membrane or geomembrane M can be textured on both sides.

Optionally, the non-woven synthetic textile lower layer 23 can comprise a needle punched synthetic non-woven. Optionally, the needle-punched non-woven synthetic textile layer 23 comprises a polypropylene. Optionally, the needle-punched non-woven synthetic textile layer 23 can comprise other polymers, such as polyethylene, polyester or nylon. Optionally, the needle-punched non-woven synthetic textile layer 23 comprises fiberglass. Optionally, the needle-punched non-woven synthetic layer is in the form of a relatively thick mat of fibers. Optionally, the non-woven synthetic textile lower layer 23 can comprise a continuous filiament synthetic non-woven.

Optionally, the non-woven synthetic textile lower layer 23 can affixed to the upper woven synthetic fabric layer 21. This can be done by adhering or bonding the non-woven synthetic textile lower layer to the woven synthetic fabric layer 21. This can be accomplished by the use of adhesives, heat, needle punching, etc. Moreover, this can be done before or after the synthetic fabric layer 21 is tufted.

Generally speaking, nonwoven fabric is a fabric-like material made from staple fiber (short) and long fiber (continuous long), bonded together by chemical, mechanical, heat or solvent treatment. Typically, the non-woven fabrics can be divided into 8 types according to different manufacturing processes: spunlace; heat-bonded; air-laid; wet-laid; spunbond; meltblown; needle punch; and stitch.

Alternatively, the non-woven synthetic textile layer 23 can comprise an air-laid synthetic non-woven fabric. The manufacturing process for making an air-laid synthetic non-woven fabric involves making a web of random fiber orientation while being formed and supported under air vacuum until the fibers are heat bonded together.

Preferably, the non-woven synthetic textile layer 23 is between about 2 oz/yd² and 18 oz/yd² mass per unit area. Preferably, the non-woven synthetic textile layer 23 is between 3 oz/yd² and 12 oz/yd² mass per unit area. Non-wovens denier ranges typically are between 0.1 and 20, but for this application it would be between 1 and 10.

### Test Results on a Blown Film Textured Geomembrane

Starting with a synthetic turf with a known woven backing, tests were performed on a blown film textured geomembrane establishing a baseline of a peak interface shear strength yielding to sliding movement at 17 degrees. A synthetic turf having first composite backing yielded a peak interface shear strength yielding to sliding movement at 29 degrees, a 70% improvement over the baseline. A synthetic turf having second composite backing yielded a peak interface shear strength yielding to sliding movement at 23 degrees, a 35% improvement over the baseline.

### Test Results on a Calendared Textured Geomembrane

Starting with a synthetic turf with a known woven backing, tests were performed on a calendared textured geomembrane establishing a baseline of a peak interface shear strength yielding to sliding movement at 21 degrees. A synthetic turf having first composite backing yielded a peak interface shear strength yielding to sliding movement at 30 degrees, a 43% improvement over the baseline. A synthetic turf having second composite backing yielded a peak interface shear strength yielding to sliding movement at 37 degrees, a 76% improvement over the baseline.

Advantageously, the non-woven synthetic textile layer 23 also provides for excellent intimate contact with the soil subgrade of the membrane/geomembrane M, and in particular provides good resistance to slipping on sloping surfaces. The non-woven synthetic textile layer 23 can also provide good cushioning protection of the membrane, good puncture resistance, improved drivability on the turf, better filtration of granular infill fines (small particles), etc. The non-woven synthetic textile layer 23 can also provide greater resistance to wrinkling.

Preferably, the synthetic turf 40 is used as the upper component of the synthetic ground cover system. It can be constructed using a knitting or tufting machine that may use over 1,000 needles to produce a turf width of about 15 feet. Preferably, the synthetic turf includes synthetic grass blades 41 comprising polyethylene or polypropylene fibers tufted to have a blade length of between about 1 inches and 4 inches. More preferably, the synthetic grass blades 41 are tufted to have a blade length of between about 1 inches and 3 inches. Most preferably, the synthetic grass blades 41 are tufted to have a blade length of about 1 to 1½ inches.

Optionally, the synthetic grass blades 41 are tufted to have a density of between about 20 ounces/square yard and about 120 ounces/square yard. Preferably, the synthetic grass blades have a thickness of at least about 100 microns.

The synthetic grass blades 41 are tufted through composite backing 20. Thus, the synthetic grass blades 41 are tufted to the woven layer(s) and the non-woven layer. In this regard, the woven layers 21 and 22 acts as a basic substrate and provides excellent strength as a substrate. The non-woven layer 23 is not as strong as the woven layers 21, 22, but provides good interface shear strength. Thus, the composite backing 20 has the best features of the two disparate materials-good interface shear strength from the non-woven layer and good strength from the woven layers.

The chemical composition of the synthetic turf blades 41 should be selected to resist damage due to exposure to sunlight, which generates heat and contains ultraviolet radiation. Further, the polymer yarns should not become brittle when subjected to low temperatures. The selection of the synthetic grass color and texture should be aesthetically pleasing.

The actual grass-like components preferably consist of green polyethylene fibers 41 of about 1 to about 1.5 inches in length tufted into the woven geotextile layer 20. The polyethylene grass filaments preferably have an extended operational life of at least 15 years.

Optionally, the synthetic turf is engineered to have polyethylene fibers with a length of 1 to 1.5 inches tufted into two fabrics consisting of needle punch non-woven polyester and woven polypropylene geotextiles. Optionally, a sand or other granular layer of about 0.5 to about 1.0 inches can be placed atop the synthetic turf as desired as infill to ballast the material and protect the system against wind uplift. The sand or granular infill will provide additional protection of the geotextiles against ultraviolet light.

This invention combines the use of a synthetic grass to provide a pleasant visual appearance, erosion protection with very minimal maintenance. The invention incorporates a composite backing with a high interface shear strength non-woven lower layer and one or more woven upper layers. Thus, the cover system of this invention can be installed on steep slopes which typically occur in embankments, levees, dams, landfills and stockpiles without sliding down.

There are many advantages to the cover system of this invention. The cover system reduces construction costs, reduces annual operation and maintenance costs while providing superior and reliable/consistent aesthetics. It also reduces the need for expensive riprap channels and drainage benches, with substantially no erosion or siltation problems, even during severe weather. It is a good choice in sensitive areas where soil erosion and sedimentation are major concerns because soil loss is substantially reduced. It also eliminates the need for siltation ponds and associated environmental construction impacts. It allows for steeper slopes, because there will be a reduced risk of soil stability problems.

While the invention has been shown and described in exemplary forms, it will be apparent to those skilled in the art that many modifications, additions, and deletions can be made therein without departing from the spirit and scope of the invention as defined by the following claims.

What is claimed is:

1. A synthetic turf cover system for erosion protection, wherein the synthetic turf cover system comprises:
a composite backing comprising a non-woven synthetic textile lower layer and a woven textile upper layer positioned above and adjacent the non-woven synthetic textile lower layer; and
synthetic grass blades extending above the composite backing and through the composite backing, the synthetic grass blades being tufted into the composite backing.

2. A synthetic turf cover system as claimed in claim 1 wherein the non-woven synthetic textile lower layer comprises a needle punched synthetic non-woven.

3. A synthetic turf cover system as claimed in claim 1 wherein the non-woven synthetic textile lower layer comprises an air-laid synthetic non-woven.

4. A synthetic turf cover system as claimed in claim 1 wherein the non-woven synthetic textile lower layer comprises continuous filaments.

5. A synthetic turf cover system as claimed in claim 1 wherein the non-woven textile layer is positioned for direct contact with a ground surface or with a membrane covering a ground surface.

6. A synthetic turf cover system as claimed in claim 1 wherein the woven textile upper layer comprises a first woven textile and a second woven textile.

7. A synthetic turf cover system as claimed in claim 1 further comprising a geomembrane positioned beneath the composite backing and atop a surface of the ground.

8. A synthetic turf cover system as claimed in claim 1 wherein the synthetic grass has a density of between about 20 ounces per square yard and 120 ounces per square yard.

9. A synthetic turf cover system as claimed in claim 1 wherein the synthetic grass comprises blades with a thickness of at least about 100 microns.

10. A synthetic turf cover system as claimed in claim 1 wherein the non-woven synthetic textile lower layer is between about 2 oz/yd² and 18 oz/yd² mass per unit area.

11. A synthetic turf cover system as claimed in claim 1 wherein the synthetic grass blades comprise fibers with an average length of between about 1 and 1½ inches.

12. A synthetic turf cover system for erosion protection, comprising:
a geomembrane to be positioned atop a ground surface; and
a synthetic turf positioned atop the geomembrane and comprising a composite backing comprising a non-woven synthetic textile lower layer and a woven textile upper layer positioned above and adjacent the non-woven synthetic textile lower layer; and synthetic grass blades extending above the composite backing and through the composite backing, the synthetic grass blades being tufted into the composite backing.

13. A synthetic turf cover system as claimed in claim 12 wherein the non-woven synthetic textile lower layer comprises a needle punched synthetic non-woven.

14. A synthetic turf cover system as claimed in claim 12 wherein the non-woven synthetic textile lower layer comprises an air-laid synthetic non-woven.

15. A synthetic turf cover system as claimed in claim 12 wherein the non-woven synthetic textile lower layer is between about 2 oz/yd² and 18 oz/yd² mass per unit area.

16. A synthetic turf cover system as claimed in claim 12 wherein the woven textile upper layer comprises a first woven textile and a second woven textile.

17. A synthetic turf cover system as claimed in claim 12 wherein the synthetic grass has a density of between about 20 ounces per square yard and 120 ounces per square yard.

18. A synthetic turf cover system as claimed in claim 17 wherein the synthetic grass comprises blades with a thickness of at least about 100 microns.

19. A synthetic turf cover system as claimed in claim 12 wherein the non-woven synthetic textile lower layer comprises continuous filaments.

20. A synthetic turf cover system for erosion protection, wherein the synthetic turf cover system comprises:
a composite backing comprising a non-woven synthetic textile lower layer and a woven textile upper layer positioned above and affixed to the non-woven synthetic textile lower layer; and
synthetic grass blades extending above the composite backing and through the composite backing, the synthetic grass blades being tufted into at least the woven textile upper layer of the composite backing.
